(19) United States
(12) Patent Application Publication
(10) Pub. No.: US 2004/0173106 A1
(43) Pub. Date: Sep. 9, 2004

(54) Pneumatically driven wringer for use on an open barrell

(76) Inventor: Jean Rouleau, Ste-Foy (CA)

Correspondence Address: DEVINE, MILLIMET & BRANCH, P.A., 111 AMHERST STREET, BOX 719, MANCHESTER, NH, 03105, US

(21) Appl. No.: 10/378,459

(22) Filed: Mar. 3, 2003

(51) Int. Cl. A47L 13/60; B30B 15/34

(52) U.S. Cl. 100/327; 15/262

(57) ABSTRACT

The rag wringer is for use on an open barrel. It comprises a frame including to spaced-apart rails configured and disposed to engage the upper rim of the barrel. It further comprises a roller assembly having two parallel and horizontally-disposed rolls operatively connected to the frame. A pneumatic drive unit, including a pneumatic motor, is mechanically connected to at least one of the rolls. Damped rags enter the wringer through a rag funnel having an upper entry and a bottom exit, the bottom exit being juxtaposed to the entry of the roller assembly. Liquids removed from the rags are falling into a collecting pan located underneath the roller assembly. A guide plate connected to the frame below the rag exit of the roller assembly allows to direct processed rags into the barrel.

### TECHNICAL FIELD

The present invention relates generally to a wringer for removing excess liquids from rags or any equivalent absorbent and soft pliant item. It relates more particularly to a pneumatically driven wringer for use on the upper rim of an open barrel or any equivalent container. BACKGROUND

Over the years, many devices have been devised for removing excess liquids from rags. Many of them involve the use of a pair of pressing rolls, which are used to compress the material of a rag in order to remove the excess liquids therefrom. The liquids fall by gravity below the wringer while the processed rag is collected at the exit, usually by hand. Such arrangement was commonly found on the top of washing machines before the arrival of the modern models. Nevertheless, conventional pressing rolls still continue to be used, for instance in wringers used to remove excess water from chamois or other absorbent items made of a soft pliant material.

While a number of different constructions have been suggested in the past, some needs were not fulfilled entirely by these available devices. One of them is the need to safely remove excess liquids from rags when the liquids are inflammable or otherwise hazardous. Some industries make an extensive use of rags for absorbing these liquids. An example of such industry is the printing industry. In this case, rags are commonly used to remove inflammable solvents. Very large printing plans require the use of an extensive number of rags each day. Presently, the damped rags are simply put into a barrel and sent as such to a specialized cleaner.

There are many drawbacks from using barrels to store and transport rags damped with solvents or otherwise hazardous liquids. Liquids eventually accumulate at the bottom of the barrel and the barrel may leak if it is defective. Another related drawback is that the quantity of hazardous liquids in a given barrel may be very high once it is full. This may require additional handling and storing precautions, all of which increase the overall operational costs. A further drawback of this situation is that cleaning rags filled with inflammable liquids using conventional industrial washing machines can be highly dangerous since a spark or another source of heat may easily trigger an explosion or a fire.

Considering this background, it clearly appears that there was a need in the industry to develop an improved way of handling damped rags, especially those filled with inflammable or otherwise hazardous liquids.

### SUMMARY

In brief, the rag wringer of the present invention comprises a frame including two spaced-apart rails configured and disposed to engage the upper rim of an open barrel. It further comprises a roller assembly having two parallel and horizontally-disposed rolls operatively connected to the frame. A pneumatic drive unit, including a pneumatic motor, is mechanically connected to at least one of the rolls. Damped rags enter the wringer through a rag funnel having an upper entry and a bottom exit, the bottom exit being juxtaposed to the entry of the roller assembly. Liquids removed from the rags are falling into a collecting pan located underneath the roller assembly. A guide plate connected to the frame below the rag exit of the roller assembly allows to direct processed rags into the barrel.

These and other aspects of the present invention are described in or apparent from the following detailed description of a preferred embodiment made in conjunction with the accompanying figures.

### BRIEF DESCRIPTION OF THE FIGURES

FIG. 1 is a right and upper perspective view of a wringer in accordance with a preferred embodiment of the present invention, the wringer being shown mounted on a conventional open barrel;

FIG. 2 is a view similar to FIG. 1, showing the wringer only;

FIG. 3 is a left and upper perspective view of the wringer shown in FIG. 1;

FIG. 4 is a right and bottom perspective view of the wringer shown in FIG. 1;

FIG. 5 is a left and bottom perspective view of the wringer shown in FIG. 1;

FIG. 6 is a top plan view of the wringer shown in FIG. 1;

FIG. 7 is a right elevation view of the wringer shown in FIG. 1, the wringer being shown without the right vertical post and some components of the pneumatic drive unit; and

FIG. 8 is a rear view of the wringer shown in FIG. 1, the wringer being shown without the funnel.

### DETAILED DESCRIPTION

The appended figures show a rag wringer (10) in accordance with the preferred embodiment of the present invention. It should be understood that the present invention is not limited to the illustrated implementation and that various changes and modifications may be effected therein without departing from the scope of the appended claims. It should also be noted that throughout the figures, parts which are not referred to may correspond to the same parts which are shown in other figures. Some of the reference numerals were not repeated for clarity of the drawings.

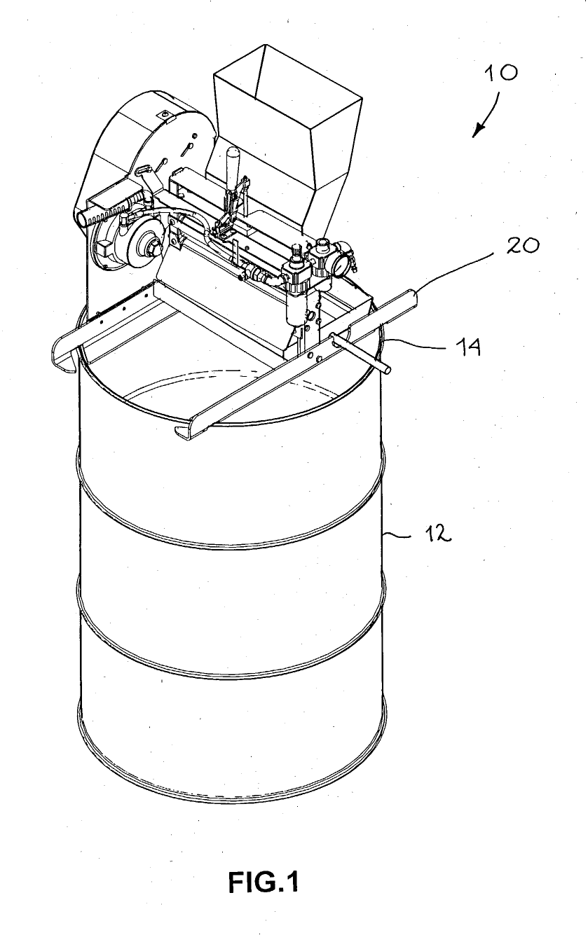

As shown in FIG. 1, the wringer (10) is designed to be used in conjunction with a conventional open barrel (12) or any similar equivalent container with an opened upper side. Unlike in the case of conventional wringers, the barrel (12) is used to collect the processed rags and not the liquids removed from the rags. This will be explained further in the text.

The wringer (10) comprises a frame (20) to which the other components are connected. This frame (20) includes a pair of spaced-apart longitudinal rails (22) which are configured and disposed to engage the upper rim (14) of the barrel (12). In the preferred embodiment, these longitudinal rails (22) are parallel and having a L-shaped cross section. They are also rigidly connected together by transversal rails (24). The ends of each longitudinal rail (22) are provided with a notch (26), or any other equivalent kind of indentation, which is designed to fit over the upper rim (14) of the barrel (12). The notches (26) preferably define an angle with reference to the transversal direction of the wringer (10). This configuration allows the wringer (10) to be installed directly over the barrel (12). The notches (26) in the longitudinal rails (22), combined with the weight of the apparatus, allow the wringer (10) to remain steady on the barrel (12) for as long as needed. The wringer (10) is moved from one barrel to another when needed.

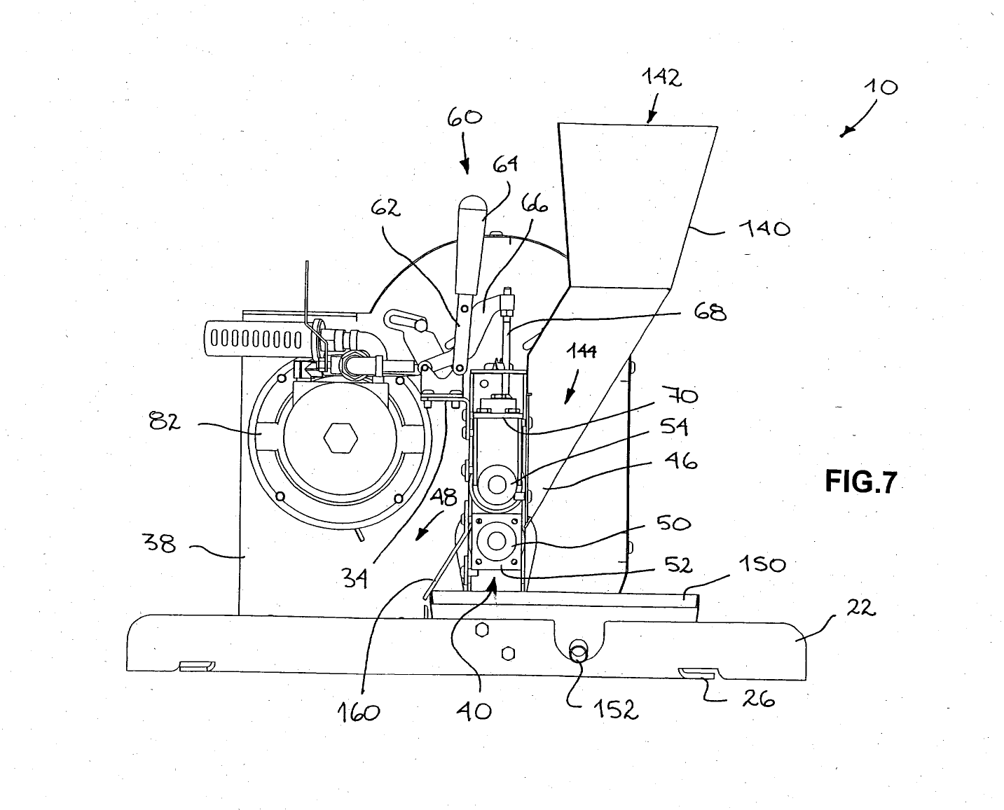

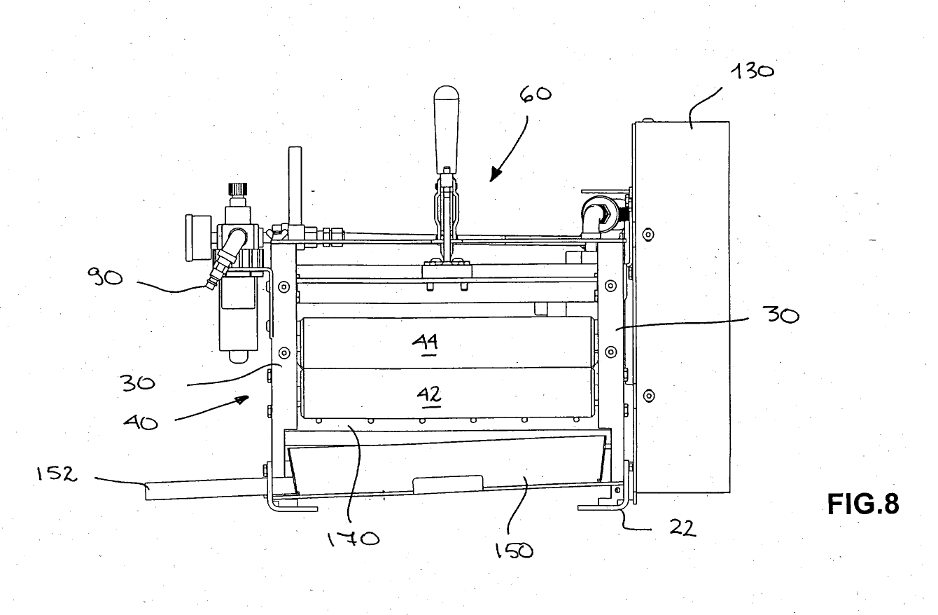

The wringer (10) comprises a roller assembly (40). As best shown in FIGS. 7 and 8, the roller assembly (40) comprises two parallel, superposed and horizontally-disposed rolls (42,44) operatively connected to the frame (20). These rolls (42,44) are transversally extending in the wringer (10) and are used to force the excess liquids out of the rags. The roller assembly (40) has a rag entry (46), situated at the right in FIG. 7, and a rag exit (48), situated at the left in FIG. 7. The wringer (10) is designed so that processed rags coming out of the rag exit (48) can fall into the barrel (12).

The exact construction of the rolls (42,44) depends on the application. The rolls (42,44) preferably comprise a rigid core or shaft covered by a slightly resilient outer layer. The material used for the outer layer is usually having a relatively high friction coefficient. The exact construction of the rolls (42,44) will be known to a person skilled in the art.

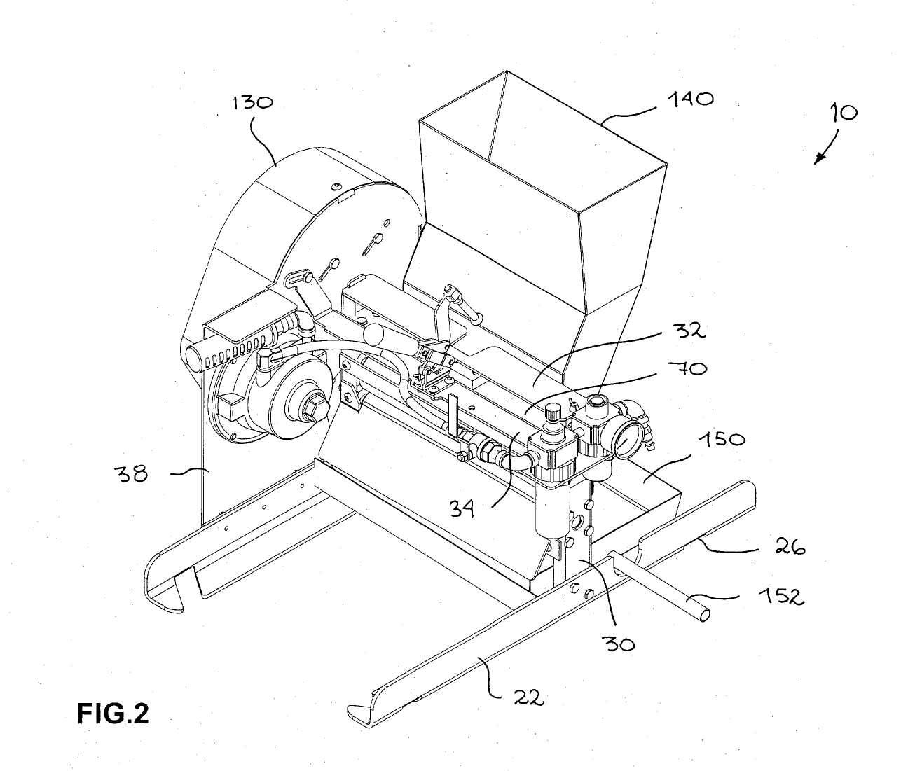

The rolls (42,44) are supported by the frame (20), preferably between a pair of opposite C-shaped vertical posts (30) connected to the longitudinal rails (22). In the illustrated embodiment, as shown in FIG. 2, the bottom roll (42) is supported by a pair of opposite bearings (50), each maintained in a bearing case (52) bolted or otherwise rigidly attached to the corresponding vertical post (30). One or more transversal rails (32) are used to rigidly connect together the upper portion of the vertical posts (30).

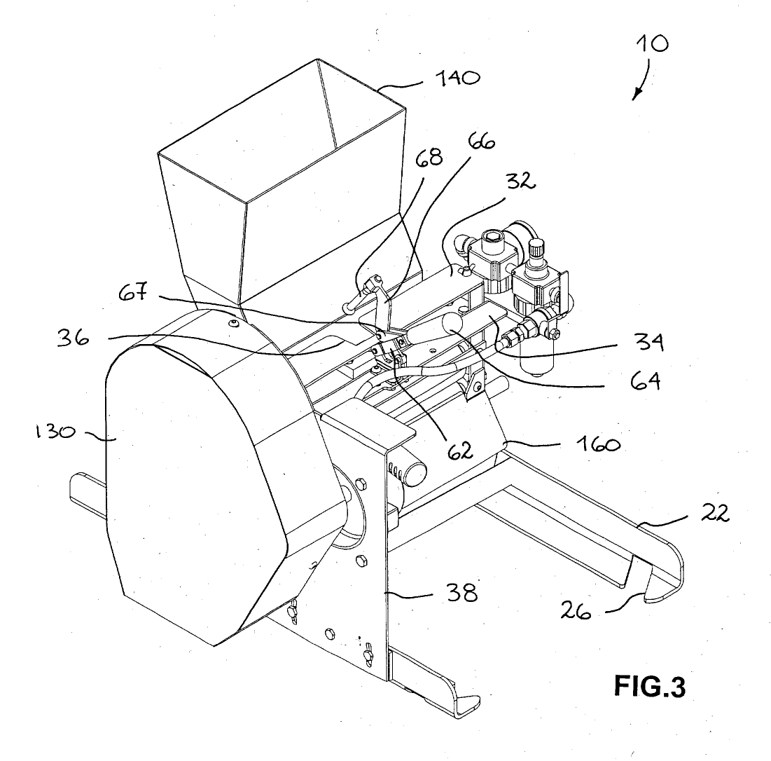

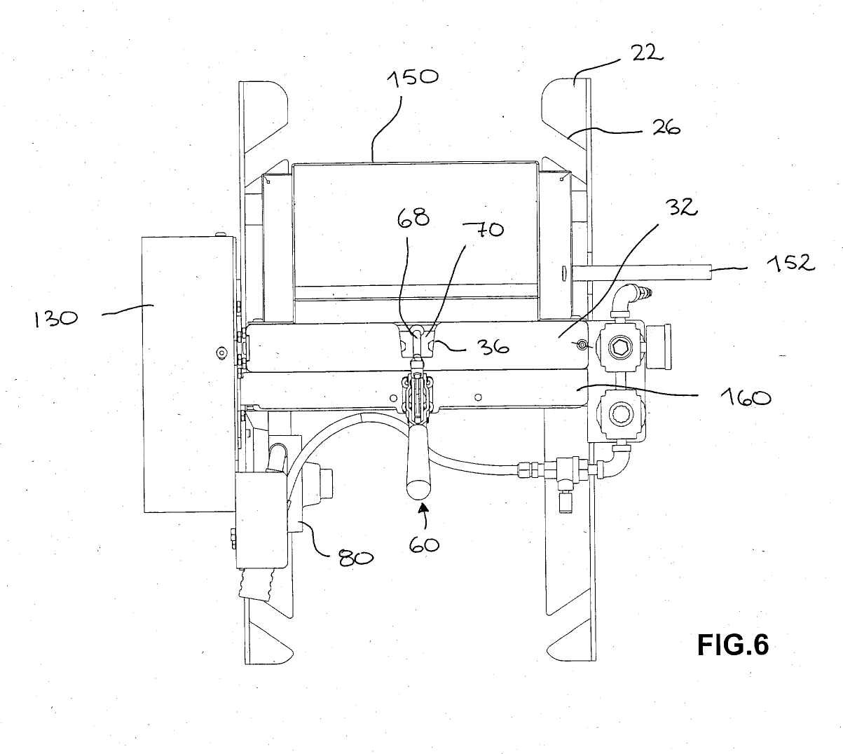

If desired, the upper roll (44) can be provided at a fixed location with reference to the vertical posts (30), leaving only a small gap between the rolls (42,44) between which the rags will be forced to go. However, for added efficiency, the upper roll (44) is preferably allowed to move with reference to the bottom roll (42). A pressing assembly is then used for controlling the pressure applied on the rags when passing between the pair of rolls (42,44). This pressing assembly can use a spring arrangement (not shown) in order to maintain a force on the upper roll (44) towards the bottom roll (42) or simply a stopper (not shown). However, in the preferred embodiment, the pressing assembly (60) is designed to be manually controlled by an operator of the wringer (10). In this arrangement, the upper roll (44) is allowed to move away from the bottom roll (42) when a rag passes between them. To do so, as best shown in FIG. 7, each end of the upper roll (44) is supported by a bearing (54), itself being held by an upper spacer (56) which is free to move up and down in its vertical post (30). A downward force is applied when needed by the operator using a first lever (62) at the end of which a handle (64) is provided. The first lever (62) is pivotally connected to the frame (20) and to a second lever (66) by means of an intermediate lever (67), as shown in FIG. 3. The connection with the frame (20) is achieved by an offset transversal supporting rail (34), itself connected to the vertical posts (30). One end of the second lever (66) is pivotally connected to the transversal supporting rail (34) and the opposite end is provided with an adjustable push rod (68). The push rod (68) is configured and disposed to engage a movable transversal rail (70) resting on the two opposite spacers (56). Yet, as best shown in FIGS. 3 and 6, the overhead transversal rail (32) comprises a notch (36) so as to allow the end of the push rod (68) to reach the movable transversal rail (70).

In accordance with the present invention, the wringer (10) comprises a pneumatic drive unit (80). This pneumatic drive unit (80) includes a pneumatic motor (82) which is mechanically connected to one or the two rolls (42,44). For instance, the two rolls (42,44) can be designed with meshed gears or other kind of arrangements. In the preferred embodiment, the pneumatic motor (82) is connected to the bottom roll (42). Using the pneumatic motor (82) instead of an electrical motor has many advantages. Among other things, the pneumatic motor (82) is much safer than an electrical motor for use with volatile solvents or otherwise inflammable and hazardous liquids. It also requires less maintenance and allows the wringer (10) to be easily relocated in a plant, namely wherever a compressed air source can be found. Compressed air is supplied to the drive unit (80) through an air inlet (90).

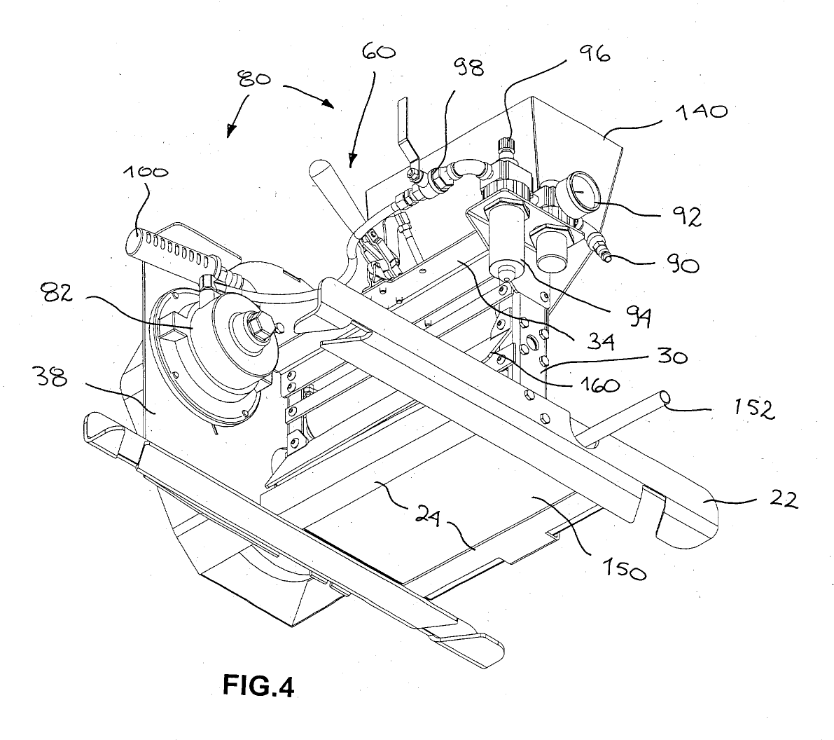

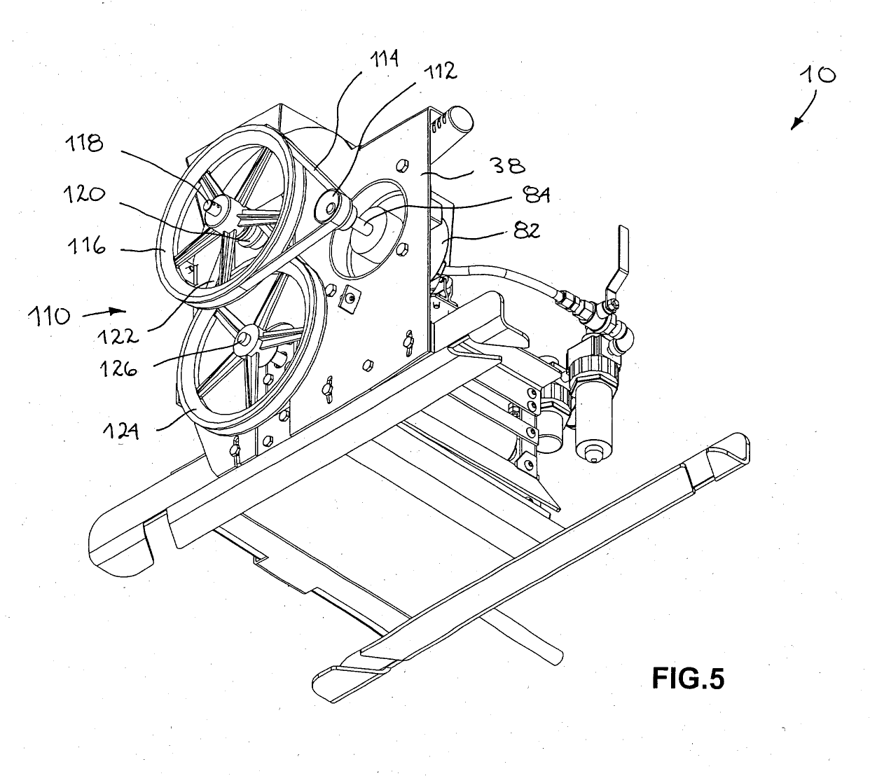

Referring now to FIG. 4, the pneumatic drive unit (80) includes additional components such as a pressure gauge (92), an air filter (94), a regulator (96), a main valve (98) and an exhaust (100). All these components are connected together by air tubes (102). The pneumatic motor (82) is preferably connected to a side plate (38) which is a part of the frame (20) of the wringer (10). The side plate (38) is bolted or otherwise connected to one of the longitudinal rails (22). Depending on the design, the mechanical connection between the pneumatic motor (82) and the roll or rolls (42,44) may need a drive train (110) with one or more stages to lower the gear ratio. In the preferred embodiment, as shown in FIG. 5, the drive train (110) comprises a small first pulley (112) secured at the end of the output shaft (84) of the pneumatic motor (82). The output torque is transferred by a first drivebelt (114) to a large second pulley (116) rigidly mounted on a shaft (118) pivotally connected to the side plate (38). The shaft (118) bears a small third pulley (120) rigidly connected thereto. From there, the torque is transferred by a second drivebelt (122) to a large fourth pulley (124) rigidly mounted on a shaft (126) at the end of which is connected the bottom roll (42). A cover (130), shown in the other figures, is used to for safety purposes on the drive train (110). It should be noted that other drive train arrangements are also possible, including ones using meshed gears.

Referring now to FIG. 7, the wringer (10) further comprises a rag funnel (140) which is used to guide the rags to the rag entry (46) of the roller assembly (40). The funnel (140) comprises an upper entry (142) and a bottom exit (144). The bottom exit (144) is juxtaposed to the rag entry (46) of the roller assembly (40) so that rags thrown into the funnel (140) at the upper entry (142) will fall by gravity to the bottom exit (144) so as to be grabbed by the roller assembly (40). Preferably, the funnel (140) is design with two or more segments set at various angles.

The wringer (10) of the present invention includes a collecting pan (150) connected to the frame (20) underneath the roller assembly (40) so as to prevent liquids removed from the rags to enter the barrel (12). As shown in FIG. 8, the collecting pan (150) is preferably inclined with reference to the horizontal plane to direct the liquids by gravity towards a fluid outlet tube (152). From there, liquids can be sent to another container for storage or treatment. It should be noted that liquids can also be otherwise removed or drained from the collecting pan (150) using other arrangements.

Preferably, the wringer (10) includes a transversally-located squeegee assembly (160) for removing most of the liquids adhering to the bottom roll (42). The squeegee (170) has a soft rubberized strip in engagement with the surface of the bottom roll (42). The strip is held by a rigid support connected between the vertical posts (30).

As can be appreciated, the wringer (10) is designed so that the processed rags and not the liquids are directed into the barrel (12) over which it is mounted. This is facilitated by the use of a transversal guide plate (160) connected to the frame (20) below the rag exit (48) of the roller assembly (40). The guide plate (160) is preferably disposed at an angle and prevents a processed rag to make contact with the edge of the collecting pan (150) at the rag exit (48). The guide plate (160) is preferably inclined with a small angle with reference to the vertical, thereby allowing the collecting pan (150) to cover the entire area below the roller assembly (40), as best shown in FIG. 7.

What is claimed is:

1. A rag wringer for use on an open barrel, the wringer comprising:
a frame including two spaced-apart rails configured and disposed to engage an upper rim of the barrel;
a roller assembly having two parallel and horizontally-disposed rolls operatively connected to the frame, the roller assembly having a rag entry and a rag exit;
a pneumatic drive unit including a pneumatic motor mechanically connected to at least one of the rolls;
a rag funnel having an upper entry and bottom exit, the bottom exit being juxtaposed to the rag entry of the roller assembly;
a liquid collecting pan connected to the frame underneath the roller assembly; and
a guide plate connected to the frame below the rag exit of the roller assembly to direct processed rags into the barrel.

2. The rag wringer in accordance with claim 1, wherein each rail comprises two opposite notches to receive the upper rim of the barrel.

3. The rag wringer in accordance with claim 2, wherein each rail has a L-shaped cross section.

4. The rag wringer in accordance with claim 1, wherein the pneumatic motor is mechanically located to at least one of the rolls by a drive train.

5. The rag wringer in accordance with claim 4, wherein the drive train comprises at least two pulleys connected together by a drivebelt.

6. The rag wringer in accordance with claim 4, wherein one of the rolls is an upper roll and the other is a bottom roll, the drive train being connected to the bottom roll.

7. The rag wringer in accordance with claim 6, wherein the upper roll is vertically movable with reference to the bottom roll.

8. The rag wringer in accordance with claim 7, wherein the upper roll is mounted on bearings movable between a pair of opposite vertical posts.

9. The rag wringer in accordance with claim 8, further comprising means for applying a pressure on the upper roll towards the bottom roll.

10. The rag wringer in accordance with claim 9, wherein the means for applying a pressure on the upper roll comprise:
an offset transversal rail connected to vertical posts of the frame;
a lever assembly pivotally connected to the transversal rail, the lever assembly comprising a push rod and a handle; and
a movable transversal rail set between the vertical posts and in engagement with the bearings of the upper roll;
whereby the push rod is configured and disposed to engage the movable transversal rail in order to transfer thereto a force applied by an operator on the handle.

11. The rag wringer in accordance with claim 10, wherein the push rod has an adjustable length.

12. The rag wringer in accordance with claim 1, wherein the liquid collecting pan comprises an outlet tube.

13. The rag wringer in accordance with claim 12, wherein the liquid collecting pan is disposed at an angle with reference to the horizontal to direct liquids towards to the outlet tube.

14. The rag wringer in accordance with claim 1, wherein the guide plate is inclined with reference to the vertical.

15. The rag wringer in accordance with claim 1, further comprising a squeegee assembly connected to the frame and in engagement with the bottom roll.
